(19) United States
(12) Patent Application Publication
(10) Pub. No.: US 2006/0251692 A1
(43) Pub. Date: Nov. 9, 2006

(54) Use of glycol ethers as biodispersants in heating and cooling systems

(76) Inventors: Jean Desroches, Boucherville (CA); Jean-Jacques Drieux, Boucherville (CA); Jacques Pichet, Varennes (CA)

Correspondence Address: CHOATE, HALL & STEWART LLP, TWO INTERNATIONAL PLACE, BOSTON, MA, 02110, US

(21) Appl. No.: 11/412,462

(22) Filed: Apr. 27, 2006

(30) Foreign Application Priority Data
May 9, 2005 (CA) 2,507,176

(51) Int. Cl. A01N 31/14; A01N 25/00

(52) U.S. Cl. 424/405; 514/723

(57) ABSTRACT

Disclosed is a method for controlling the formation of biofilms in cooling water systems or closed systems wherein water is cooled, heated and recirculated, by injecting a glycol ether or mixture of glycol ethers as biodispersant in the water of such systems. The glycol ethers are chosen to be soluble in water. The preferred glycol ethers result from the reaction between one or more alcohols with one or more epoxides, preferably chosen from ethylene oxide and propylene oxide.

### RELATED APPLICATIONS

This application claims priority to Canadian Patent Application No. 2,507,176, filed May 9, 2005, which is incorporated herein by reference in its entirety.

### FIELD OF THE INVENTION

The present invention relates to a method for controlling the formation of biofilms in thermal exchange systems wherein water acts as a heat-conveying fluid by using a glycol ether or a mixture of glycol ethers as biodispersant.

Such thermal exchange systems in particular include systems where heating water is recirculated in a closed pipe system and systems where cooling water is used, such as cooling towers or closed systems where water is cooled.

### BACKGROUND ART

The presence of biofilms is an important problem in thermal exchange systems wherein water acts as a heat-conveying fluid. Indeed, the accumulation of a large quantity of a microbiological film may significantly interfere with the free circulation of the water in the pipes, leading to a deficient thermal exchange and it may eventually cause a poor general hygiene of heating transfer systems. The “Betz Handbook of Industrial Water Conditioning”, H. L. Boyer et al., 1962 (Sixth edition), Betz Laboratories, Trevose, Pa., p. 288-299, gives more precision about such phenomenon.

It is also well known that those corrosion phenomena are promoted in the presence of biofilms involving structural consequences. The presence of biofilms also involves some risks of bacterial contamination when water is used in a cooling tower. The most famous case was identified in 1976 in Philadelphia when the Legionella bacterium was identified for the first time.

Many articles have been published about biofilms in cooling and heating systems wherein water acts as the heat transfer medium.

Biofilms are considered as environmental nuisances and various approaches have been adopted in order to remove them from existing systems or to prevent their formation.

Invasive mechanical brushing means and means for cleaning cooling systems such as those described in the U.S. Pat. Nos. 6,080,323 and 6,840,251, are commonly used. But these techniques are expensive, they are difficult to carry out and their results are unpredictable.

U.S. Pat. Nos. 6,830,745, 6,777,223, 6,641,828, 6,652,889, 6,638,959, 6,551,624, 6,514,458, 6,498,862, 6,468,649, 6,455,031, 6,423,219 and 6,419,879 also suggest the use of important quantities of biocides to try to dig out the microbiological deposits. But the results are not much convincing since, even if the water in recirculation does not contain bacteria, algae, fingi or other microorganisms, this does not mean that no biofilm is present. Indeed, in cooling water systems, the proportion of forming bacteria can exceed 90% of the total bacterial count.

U.S. Pat. Nos. 6,039,965, 5,670,055, 6,139,830 and 5,512,186 also propose the use of surfactants for dispersing biofilms.

By significantly decreasing the tension surface and using other tricks, the inventors of these patents have shown that this method is somehow efficient for removing biofilms. However, the surfactants that they use show foam characteristics which might significantly hinder the good working order of a cooling tower or a heating system.

There are other limitations besides those that are related to the foaming due to specific use of ionic surfactants. For instance, the use of non-ionic surfactants such as “block” polymer is limited in systems wherein the water temperature is greater than the surfactant's cloud point. Indeed, the surfactant which is usually soluble in water at temperatures lower than the cloud point becomes insoluble when the temperature of the water is greater than this cloud point, and is therefore no longer available to depress the surface tension or other properties.

The use of a surfactant, although it has undeniable tensioactive properties, however shows numerous disadvantages. The present invention offers a more neat method which is adapted for both cooled water systems and heating water.

Other methods which use detergent and bactericide combinations are also described in the literature and have been patented. The use of enzymes to dig out biofilms of the inside walls is another method which is described in U.S. Pat. Nos. 6,630,197 and 4,936,994.

Various techniques which are described in the literature are used for controlling and destroying biofilms. In particular, U.S. Pat. Nos. 6,790,429, 6,710,017 and 6,673,248 describe the use of an ozone generator. Ultrasound treatments are used in U.S. Pat. Nos. 6,706,290, 6,699,684 and 5,889,209. U.S. Pat. Nos. 6,777,223 and 5,411,666 also describe the use of enzymes. U.S. Pat. Nos. 6,533,942 and 6,332,979 disclose electric methods. U.S. Pat. No. 5,382,367 is directed to the use of hydrogen peroxide. U.S. Pat. Nos. 6,395,189 and 6,149,822 describe the use of an amine-formaldehyde condensate. The use of electric fields is recommended in U.S. Pat. Nos. 5,462,644 and 5,312,813. U.S. Pat. No. 6,379,563 also describes the use of primary alkylamines. The use of mixtures of alkyl sulfates, alkyl sulfonates and aryl sulfonates in an acid medium is disclosed in U.S. Pat. No. 6,812,196. Finally, U.S. Pat. No. 6,211,172 describes the use of sulfoamides.

The approach proposed in this context by the present invention, which recommends the use of glycol ethers as biodispersants, has never been described and published up to date. More particularly, the use of glycol ethers as biodispersants in cooling towers and/or in system wherein heated and cooled water is recirculated represents an innovation in this particular field.

### OBJECTS OF THE INVENTION

Nowadays, planktonic and bacterial measurements are the most frequently used methods to measure the microbiological activity in a heating exchange system wherein water acts as the heat-conveying vector. Techniques for direct measurement (bacterial cultures) or indirect measurement such as the quantification of ATP (Adenosine triphosphate) are commonly used and known to be reliable.

However, an important limitation in regard to such diagnostic instruments should be mentioned: more than 99% of the organisms which grow in cooling towers are fixed on the surfaces of the mechanical structures and are not detected by these measurement techniques.

The adherent populations might be found in spots with low turbulences and therefore are not counted in the total bacterial counting. Studies have actually shown that there is no direct relation between the contamination of the circulating water of a system and the microbiological activity on the inside walls of this system.

The present inventors have discovered that molecules like glycol ethers may be used to dig out biofilms and allow a better water circulation, and therefore a more efficient thermal exchange because of the surfaces which become free of interferences.

The present inventors have also discovered that the dispersion of the biofilms is possible without using surfactant and bactericide. Accordingly, the application constraints are reduced and the manipulation of the chemical product used as the biodispersant is not subjected to the safety and environmental rules relating to biocides and bactericides.

The approach proposed by the present invention is significantly less invasive on the environment than the traditional techniques wherein the biodispersant is coupled with a biocide. The use of the biodispersant alone may significantly decrease the fixation of the microorganisms on the inside walls of the heating or cooling equipments and, then may prevent the biofilms formation.

Glycol ethers have been chosen because they have a low foaming power and no cloud point. Moreover, some of them do not show any environmental, health and safety risk.

Many studies have been carried out in real conditions in order to establish the parameters related to the use of glycol ethers as biofilms breaking and dispersing agents.

These studies have been performed using a scale model of a water cooling system. The clogging and heat transfer have been monitored using a DATS™ (Deposit Accumulation Testing System) for the studies in the pilot cooling tower as well as for on site applications. The DATS™ is a particularly useful instrument for biofilms studies. In order to obtain reliable results, it is however necessary to check that the studied system is in a dispersed phase in regard to inorganic salts (i.e. carbonates and calcium bicarbonates) to avoid that these salts interfere with the data collected by the apparatus. The use of common dispersants based on polycarboxylic polymers and organophosphates is simple and gives good results in the situation in which the tests have been carried out for controlling this constraint.

### SUMMARY OF THE INVENTION

A first object of the present invention is thus to provide a method for controlling the formation of biofilms in a cooling water system or in a closed system wherein water is heated, cooled and recirculated, comprising injecting at least one glycol ether as a biodispersant in the water of such system.

Preferably, the present invention provides a method for controlling the formation of biofilms in a cooling tower.

The glycol ethers used in accordance with the invention are products which result from the reaction of an alcohol (primary, secondary or tertiary) with an epoxide. Preferably, the epoxide is selected from the group consisting of ethylene oxide and propylene oxide. The stoichiometric ratios of epoxide to alcohol may vary but they are never sub-stoichiometric. In other words, the stoichiometric ratio of epoxide to alcohol is equal to or higher than 1. In many cases, the ratios are preferably sup-stoichiometric with at least two moles of the epoxide reacting with one mole of the alcohol. The stoichiometric ratio of epoxide to alcohol is therefore more preferably equal to at least 2. The ratios may also be greater.

The glycol ethers used in the present invention are soluble in water in any proportion and, unlike surfactants, they almost not foam. This is particularly due to the fact that glycol ethers has a less significant impact on the water tension surface compared to the common surfactants used as biodispersants. For example, a “block” copolymer (such as Pluronic® L62LF, BASF) presents a tension surface of 39 dynes/cm at 0.1% in water at 25° C., whereas a glycol ether such as the tripropylene glycol methyl ether presents a tension surface of about 60-65 dynes/cm in the same conditions (Physico-chemical characteristics described in “The Glycol Ethers Handbook”, Dow Chemical U.S.A., Midland, Mich., 1982, p. 5 and 6 and Table 7 p. 41).

The glycol ethers used in the present invention may be selected from the non exhaustive following lists:
ethylene glycol methyl ether,
ethylene glycol ethyl ether,
ethylene glycol n-butyl ether,
diethylene glycol methyl ether,
diethylene glycol ethyl ether,
diethylene glycol n-butyl ether,
triethylene glycol methyl ether,
and their homologues of higher molecular weight,
triethylene glycol ethyl ether and its homologues of higher molecular weight,
triethylene glycol n-butyl ether and its homologues of higher molecular weight,
propylene glycol methyl ether,
dipropylene glycol methyl ether, and
tripropylene glycol methyl ether.

More preferably, the glycol ether used according to the invention is tripropylene glycol ethyl ether or dipropylene glycol methyl ether.

The present invention also concerns mixtures of glycol ethers and their aqueous solutions.

Moreover, the use of glycol ethers according to the invention is compatible with other elements such as injection systems or chemical and physical anti-corrosion treatments, the scaling treatment, the microbiological control and the clogging.

The use of glycol ethers may be carried out with or without bactericide.

An important other object of the invention is attributable to the fact that the glycol ethers do not present a cloud point when they are in solution in water. These glycol ethers are also low foaming.

The glycol ethers used as biodispersants in the present invention may be used pure or in a diluted solution.

A second object of the present invention is therefore to provide a method for controlling the formation of biofilms in a cooling water system or in a closed system wherein water is heated, cooled and recirculated, comprising injecting at least one glycol ether as a biodispersant in the water of said system, and wherein said at least one glycol ether is water soluble, low foaming, does not present any cloud point, and results from a reaction between an alcohol and an epoxide.

A third object of the present invention is also to provide a method for controlling the formation of biofilms in a cooling water system or in a closed system wherein water is heated, cooled and recirculated, comprising injecting at least one glycol ether as a biodispersant in the water of said system, wherein said at least one glycol ether results from a reaction between an alcohol and an epoxide, wherein said epoxide and said alcohol are used in a stoichiometric ratio of epoxide to alcohol equal to or higher than 1 and wherein said alcohol is selected from the group consisting of methanol, ethanol and n-butanol.

A fourth object of the present invention is to provide a method for controlling the formation of biofilms in a cooling tower system comprising injecting at least one glycol ether as a biodispersant in the water of said system, and wherein said at least one glycol ether is tripropylene glycol methyl ether or dipropylene glycol methyl ether.

In a particularly preferred embodiment of the present invention, the glycol ether is injected in the water system to be treated at a concentration of between 500 to 10000 ppm for a shock treatment, and then the concentration should be continually maintained between 30 and 100 ppm as depending on the fresh water supplies to the system. The supply of water is constant no matter what number of concentration cycles are applied to the cooling tower. There is no superior limit concentration to respect since the glycol ether has a low reactivity and its foaming properties are significantly lower compared to those of common surfactants and of quaternary ammonium salts.

### DETAILED DESCRIPTION OF THE INVENTION

The most preferred glycol ethers which have been tested in accordance with the present invention are the tripropylene glycol methyl ether and the dipropylene glycol methyl ether.

A building downtown Montreal has been chosen as a pilot site to test the efficiency of the invention. The edifice in question is a stainless steel cooling tower comprising a tank made of soft steel having a 500 tons capacity.

The cooling water is cycled four times in function of the chloride content and the conductivity. The supply water comes from the City of Montreal and presents the following characteristics:
pH: 7.6
Alkalinity M: 84 ppm CaCO₃
Chloride: 21 ppm Cl⁻
Conductivity: 240 microohms
Total hardness: 118 ppm CaCO₃

This edifice has no corrosion background and no problem attributable to such a condition, but is likely to show scaling and formation of microbiological film.

The injection of 300 ppm of dipropylene glycol methyl ether in the recirculating water of the tower allowed first the dig out of the deposits which were covering the inside walls of the tower. This tower is equipped with two pocket filters of 5 microns. The obstruction of the two filters has been noticed at the end of the first day of treatment.

The analysis of the deposit has shown that it was constituted of a mixture of calcium carbonate and others inorganic salts.

The DATS™ clogging monitor has shown after few days of treatment with dipropylene glycol methyl ether, that the measurements were stabilized, therefore suggesting that no film was anymore present on the surfaces of the inside walls. Direct measurements of the microbiological activity have shown a downwards stabilization of the bacterial population compared to the initial state, this without any bactericide injection.

A second simulation on an other cooling tower equipment has shown similar results, always without using bactericide. In this case, the cooling tower equipment was treated with tripropylene glycol methyl ether. The treatment was followed through the marking of the bacterial counts which were present in the cooling tower. An increase in the water turbidity and a significant microbiological activity rise were noticed at the beginning of the treatment with the biodispersant used at a concentration of 200 ppm. The formation of a foam was also observed on the surface of the water tank. These observations therefore proved that a biofilm had dug out.

After few weeks, the system was stabilized and the bacterial population concentration, which was constant in the system, did not exceed 10³ UFC/ml, an acceptable value for such a cooling tower. This allowed to avoid using bactericide.

A prolonged study has also shown that when the cooled water system has reached equilibrium, no addition of biocide is required since the bacterial population observed is less than 10⁴ UFC/ml.

The biodispersant was injected in order to maintain a constant concentration of 30 ppm.

These various assays have demonstrated the importance of the present invention which not only allows to keep equipments free of biofilms, but also allows to significantly descrease the consumption of biocides in the cooling tower. The related costs are thus diminished as well as the environmental risks associated to the manipulation of bactericide in the maintenance of cooling tower.

Finally, complementary studies have been carried out using a pilot cooling tower. The aim of these studies was to confirm the results obtained for the preliminary tests and also to evaluate the impact of the use of a biodispersant on the efficiency of an anti-corrosive treatment based on phosphonates, azoles, molybdates and dispersant polymer. The glycol ethers do not have any known anti-corrosive property. Therefore, the following step was to demonstrate that they could be used at the same time as conventional anti-corrosive treatments.

No interference was observed when using dipropylene glycol methyl ether or tripropylene glycol methyl ether at concentrations of between 50 and 300 ppm. The efficiency of the conventional anti-corrosive treatment was maintained.

1. A method for controlling the formation of biofilms in a cooling water system or in a closed system wherein water is heated, cooled and recirculated, comprising injecting at least one glycol ether as a biodispersant in the water of said system.

2. The method of claim 1 wherein said cooling water system is a cooling tower.

3. The method of claim 1, wherein said at least one glycol ether results from a reaction between an alcohol and an epoxide.

4. The method of claim 3, wherein the epoxide is ethylene oxide or propylene oxide.

5. The method of claim 3, wherein the alcohol is selected from the group consisting of methanol, ethanol and n-butanol.

6. The method of claim 3, wherein the epoxide and the alcohol are used in a stoichiometric ratio of epoxide to alcohol equal to or higher than 1.

7. The method of claim 6, wherein the stoichiometric ratio of epoxide to alcohol is equal to at least 2.

8. The method of claim 1, wherein said at least one glycol ether is water soluble.

9. The method of claim 1 wherein said at least one glycol ether is injected as an aqueous solution.

10. The method of claim 1 wherein said at least one glycol ether is low foaming and does not present any cloud point.

11. The method of claim 1, wherein said at least one glycol ether is selected from the group consisting of:
ethylene glycol methyl ether,
ethylene glycol ethyl ether,
ethylene glycol n-butyl ether,
diethylene glycol methyl ether,
diethylene glycol ethyl ether,
diethylene glycol n-butyl ether,
triethylene glycol methyl ether,
and their homologues of higher molecular weight,
triethylene glycol ethyl ether and its homologues of higher molecular weight
triethylene glycol n-butyl ether and its homologues of higher molecular weight,
propylene glycol methyl ether,
dipropylene glycol methyl ether, and
tripropylene glycol methyl ether.

12. The method of claim 11, wherein said at least one glycol ether is tripropylene glycol methyl ether or dipropylene glycol methyl ether.

13. The method of claim 1 characterized in that it further comprises the adjunction of a bactericide.

14. A method for controlling the formation of biofilms in a cooling water system or in a closed system wherein water is heated, cooled and recirculated, comprising injecting at least one glycol ether as a biodispersant in the water of said system, and wherein said at least one glycol ether is water soluble, low foaming, does not present any cloud point, and results from a reaction between an alcohol and an epoxide.

15. A method for controlling the formation of biofilms in a cooling water system or in a closed system wherein water is heated, cooled and recirculated, comprising injecting at least one glycol ether as a biodispersant in the water of said system, wherein said at least one glycol ether results from a reaction between an alcohol and an epoxide, wherein said epoxide and said alcohol are used in a stoichiometric ratio of epoxide to alcohol equal to or higher than 1 and wherein said alcohol is selected from the group consisting of methanol, ethanol and n-butanol.

16. A method for controlling the formation of biofilms in a cooling tower system, comprising injecting at least one glycol ether as a biodispersant in the water of said system, and wherein said at least one glycol ether is tripropylene glycol methyl ether or dipropylene glycol methyl ether.
